(19) United States
(12) Patent Application Publication
(10) Pub. No.: US 2008/0134683 A1
(43) Pub. Date: Jun. 12, 2008

(54) Wall elements for gas turbine engine components

(75) Inventor: Marcus Foale, Swadlincote (GB)

Correspondence Address: OLIFF & BERRIDGE, PLC, P.O. BOX 320850, ALEXANDRIA, VA, 22320-4850, US

(73) Assignee: ROLLS-ROYCE PLC, London (GB)

(21) Appl. No.: 11/889,125

(22) Filed: Aug. 9, 2007

(30) Foreign Application Priority Data
Sep. 1, 2006 (GB) 0617252.2

(51) Int. Cl. F02C 1/00

(52) U.S. Cl. 60/755

(57) ABSTRACT

A wall structure for a gas turbine engine combustor has an inner wall and an outer wall defining a duct. The duct diverges as it extends in the general direction of fluid flow within the combustor. Cooling air is fed into the duct through angled cooling holes which provide a film of fluid over the outer wall of the combustor should the inner wall be eroded because of the high temperatures in the combustor.

This invention relates to wall elements for gas turbine engine combustors.

A typical gas turbine engine combustor includes a generally annular chamber having a plurality of fuel injectors at an upstream head end. Combustion air is provided through the head and through ports provided in the combustor walls downstream of the fuel injectors.

In order to improve the thrust and fuel consumption of gas turbine engines, i.e. the thermal efficiency, it is necessary to use high compressor pressures and combustion temperatures. Higher compressor pressures give rise to higher compressor outlet temperatures and higher pressures in the combustion chamber.

There is, therefore, a need to provide effective cooling of the combustion chamber walls. One cooling method which has been proposed is the provision of a double walled combustion chamber in which the inner wall is formed of a plurality of heat resistant tiles. Cooling air is directed into the duct between the outer walls and the tile from an aperture located midway along the tile. The flow of air bifurcates into upstream and downstream flows which are exhausted into the combustion chamber. Often, with this cooling air supply arrangement, to achieve reasonable cooling at the rear edge of the tile more heat removal tends to occur at the front of the tile than is necessary. A detrimentally strong temperature gradient can exist across the axial length of the tile.

The tiles can be provided with a plurality of pedestals within the duct between the outer walls and the tiles which assist in removing heat from the tile. However, it has been found that the cooling film may not persist long enough to protect the entire length of the tile and the rear edge may eventually suffer from erosion. When the erosion becomes great enough to impact on emissions or exit temperature traverse patterns the tile must be replaced. If the tile suffers greater damage and is partially or wholly lost secondary damage to the cold skin will rapidly follow since the cooling film supplied into the duct is not sufficient to cool the outer, cold skin wall to which the tiles are attached when the wall is exposed to combustion gas. Excess secondary damage is hazardous to the engine through potential flame breakout.

According to the present invention there is provided a wall structure for a gas turbine engine combustor arranged to have a general direction of fluid flow therethrough, the wall structure including an inner wall and an outer wall defining a duct therebetween, characterised in that the duct diverges as it extends in the general direction of fluid flow.

Preferably the outer wall has a plurality of apertures for feeding cooling air into the duct. The apertures may be directed at an angle of 5° to 70° to the general direction of fluid flow through the combustor. Preferably apertures are spaced in the general direction of fluid flow through the combustor.

Preferably the inner wall includes a plurality of wall elements, each wall element having a body portion and an circumferentially extending sealing element that extends from the body portion towards the outer wall of the combustor wall structure for limiting the upstream flow of cooling air within the duct.

The downstream end of an upstream wall element may overlap the upstream end of a downstream wall element.

According to a second aspect of the invention there is provided a wall element for use as part of an inner wall of a gas turbine engine combustor wall structure including inner and outer walls, the inner and outer walls defining a duct therebetween, the wall element having a body portion aligned in use with a general direction of fluid flow through the combustor and a plurality of pedestals arranged to extend within the duct from the body portion towards the outer wall with the ends of the pedestals remote from the body portion lying substantially on a common plane, wherein the length of the pedestals towards the end of the body portion intended to be the downstream end of the wall element are of a greater length than the pedestals towards the end of the body portion intended to be the upstream end of the wall element.

According to a second aspect of the invention there is provided a wall structure for a gas turbine engine combustor arranged to have a general direction of fluid flow therethrough, the wall structure including an inner wall and an outer wall defining a duct therebetween, the outer wall including a plurality of apertures for the supply of cooling fluid to the duct, wherein the apertures are directed at an angle of 5° to 70° to the general direction of fluid flow through the combustor.

Preferably the apertures are directed at an angle of 10° to 45° to the general direction of fluid flow through the combustor.

Embodiments of the present invention will now be described by way of example only and with reference to the accompanying drawings, in which:—

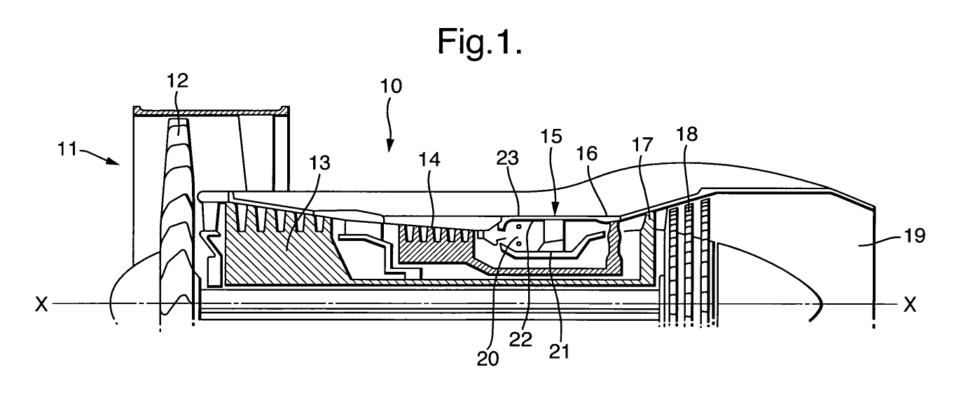

FIG. 1 is a sectional side view of the upper half of a gas turbine engine;

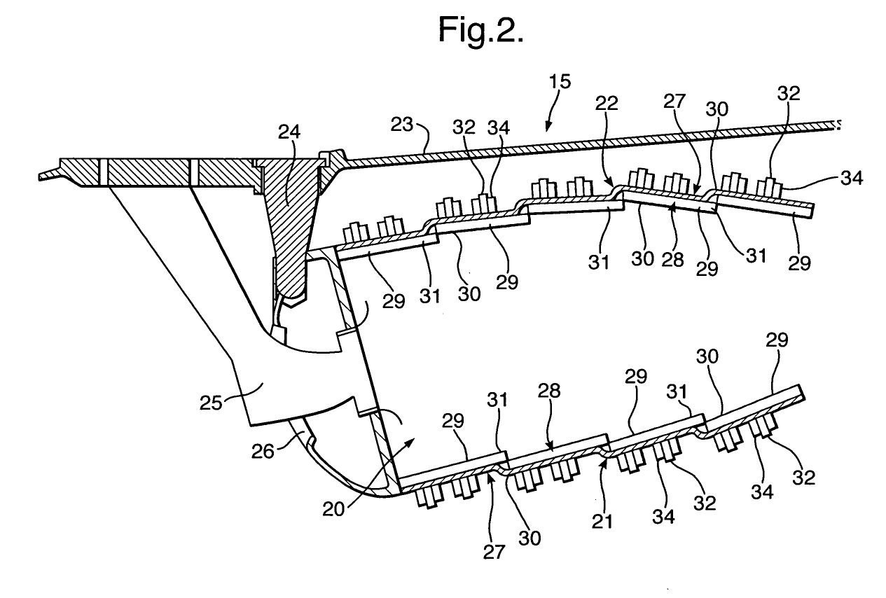

FIG. 2 is a vertical cross-section through the combustor of the gas turbine engine shown in FIG. 1;

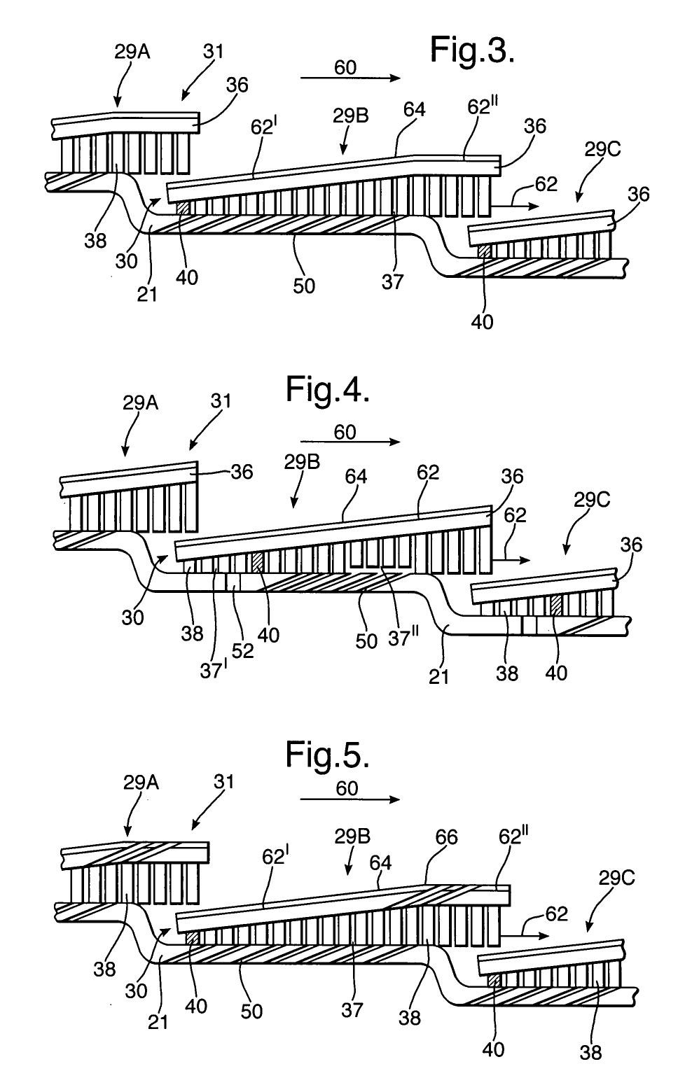

FIG. 3 is a diagrammatic vertical cross-section through part of the wall structure of the combustor shown in FIG. 1.

FIG. 4 is a diagrammatic vertical cross-section of an alternative wall structure of the combustor shown in FIG. 1.

FIG. 5 is a diagrammatic vertical cross-section of an alternative wall structure of the combustor shown in FIG. 1.

Referring to FIG. 1, a gas turbine engine generally indicated at 10 has a principal axis X-X. The engine 10 comprises, in axial flow series, an air intake 11, a propulsive fan 12, an intermediate pressure compressor 13, a high pressure compressor 14, a combustor 15, a high pressure turbine 16, an intermediate pressure turbine 17, a low pressure turbine 18 and an exhaust nozzle 19.

The gas turbine engine 10 works in a conventional manner so that air entering the intake 11 is accelerated by the fan 12 which produces two air flows: a first air flow into the intermediate pressure compressor 13 and a second air flow which provides propulsive thrust. The intermediate pressure compressor compresses the air flow directed into it before delivering that air to the high pressure compressor 14 where further compression takes place.

The compressed air exhausted from the high pressure compressor 14 is directed into the combustor 15 where it is mixed with fuel and the mixture combusted. The resultant hot combustion products then expand through, and thereby drive, the high, intermediate and low pressure turbines 16, 17, 18 before being exhausted through the nozzle 19 to provide additional propulsive thrust. The high, intermediate and low pressure turbine 16, 17, 18 respectively drive the high and intermediate pressure compressors 14 and 13, and the fan 12 by suitable interconnecting shafts.

Referring to FIG. 2, the combustor 15 is constituted by an annular combustion chamber 20 having radially inner and outer wall structures 21 and 22 respectively. The combustion chamber 20 is secured to an engine casing 23 by a plurality of pins 24 (only one of which is shown). Fuel is directed into the chamber 20 through a number of injector nozzles 25 (only one of which is shown) located at the upstream end of the combustion chamber 20. Fuel injector nozzles 25 are circumferentially spaced around the engine 10 and serve to spray fuel into air delivered from the high pressure compressor 14. The resulting fuel/air mixture is then combusted within the chamber 20.

The combustion process which takes place generates a large amount of heat. It is therefore necessary to arrange that the inner and outer wall structures 21 and 22 are capable of withstanding this heat.

The inner and outer wall structures 21 and 22 are generally of the same construction and comprise an outer wall 27 and an inner wall 28. The inner wall 28 is made up of a plurality of discrete wall elements in the form of tiles 29, which are all of the same general rectangular configuration and are positioned adjacent each other. The circumferentially extending edges 30,31 of adjacent tiles overlap each other. Each tile 29 is provided with threaded studs 32 which project through apertures in the outer wall 27. Nuts 34 are screwed onto threaded studs 32 and tightened against the outer wall 27, thereby securing the tiles 29 in place.

Referring to FIG. 3, there is shown part of the inner wall structure 21 showing three overlapping tiles. 29A, 29B, 29C. Each of the tiles 29A, 29B, 29C comprises a main body portion 36 which, in combination with the main body portions of each of the other tiles 22, defines the inner wall 28. A plurality of heat removal members in the form of upstanding substantially cylindrical pedestals 38 extend from each body member 36 towards the inner wall of the combustor 21. The downstream edge region 31 of tile 29A overlaps the upstream edge region 30 of tile 29B and the end face of the downstream edge region 31 of tile 29B overlaps the upstream edge region 30 of tile 29C.

The upstream edge of a tile 29B is provided with a wall 40 that extends circumferentially. The wall is of a length that the build up of stress sufficient to damage the wall element is avoided. At least one circumferential break is provided for each tile. The wall 40 acts as a partial seal and prevents the upstream passage of the majority of the cooling air within the duct 37.

Cooling air is fed into the duct 37 through a plurality of angled holes 50 axially spaced along the inner wall 21 of the combustor. The holes are directed at an angle of between 5° and 70° and preferably 100 and 450 to the general direction of fluid flow through the combustor 60. The air from an upstream hole moves downstream within the duct 37 and is joined by further volumes of air from downstream holes. To avoid an unacceptable pressure loss towards the downstream end 31 of the tile the area of the duct 37 increases to maintain a constant velocity of air within the duct 37.

Some of the pedestals 38 in the region of the angled holes 50 may be made slightly shorter than the pedestals in the region of fixing studs 32 to enable a gap to be provided between the end of the pedestal remote from the main body portion and the cold-skin wall 21. Beneficially, this arrangement reduces the possibility of an angled hole 50 from being blocked by a pedestal 38.

The duct diverges over the majority of its length though divergence may stop towards the downstream end 31 of the body portion 36.

At the downstream edge of the tile 29B the cooling air 62 is exhausted as a film that passes across the surface of the downstream tile 29C.

The body member provides a conic surface that slopes towards the major axis of the combustor. The conic surface may a single surface 62 or may be formed by two surfaces 62′, 62″, the second surface being arranged at an angle to the first surface.

The body member preferably has a thermal barrier coating 64 to provide further heat resistance.

Beneficially, the invention provides increased robustness to the tiles. If the tile erodes gradually the inner wall angled effusion holes form a cooling film over the inner surface of the wall to provide limited protection. The film of air enables the inner wall to maintain its integrity for a longer period while it is exposed to the hot flame than if the film of air was not present.

Additionally, the angled effusion directs air consistently towards the base of the pedestals, which are adjacent the inner or outer walls and consequently offers high heat transfer.

By gradually feeding air into the duct the thermal stresses that can be caused by providing high quantities of cooling air at fewer locations is mitigated.

FIG. 4 depicts an alternative embodiment of a wall structure in accordance with the invention. The body portion 36 continually diverges from the outer wall to provide a duct 37 of increasing cross section. The sealing element 40 is located part way along the wall element to divide the duct into an upstream portion 37′ and a downstream portion 37″. The upstream portion 37′ is supplied with a first flow of cooling fluid from an aperture 52 the flow being optimised to provide cooling to the upstream end of the body portion. The downstream portion of the duct is supplied with cooling from angled effusion holes 50 as before.

Beneficially, this embodiment allows cooling flows to be optimised for both the upstream end of the wall element and the downstream end of the wall element.

FIG. 5 depicts a further alternative embodiment of a wall structure in accordance with the invention. The body portion 36 diverges from the outer wall to provide a duct 37 of increasing cross section. The downstream end of the body portion is provided with angled cooling holes 66 that direct air from the duct to create a thin film over the downstream end of the tile to further protect the tile from erosion.

Various modifications may be made without departing from the scope of the invention.

1. A wall structure for a gas turbine engine combustor arranged to have a general direction of fluid flow therethrough, the wall structure including an inner wall and an outer wall defining a duct therebetween, the outer wall including a plurality of apertures for the supply of cooling fluid to the duct, wherein the apertures are directed at an angle of 5° to 70° to the general direction of fluid flow through the combustor.

2. A wall structure according to claim 1, wherein the apertures are directed at an angle of 10° to 45° to the general direction of fluid flow through the combustor.

3. A wall structure for a gas turbine engine combustor arranged to have a general direction of fluid flow therethrough, the wall structure including an inner wall and an outer wall defining a duct therebetween, wherein the duct diverges as it extends in the general direction of fluid flow, wherein the outer wall has a plurality of apertures for feeding cooling air into the duct, the apertures being directed at an angle of 5° to 70° to the general direction of fluid flow through the combustor.

4. A wall structure according to claim 3, wherein the apertures are spaced in the general direction of fluid flow through the combustor.

5. A wall structure according to claim 1, wherein the inner wall includes a plurality of wall elements, each wall element having a body portion and an circumferentially extending sealing element that extends from the body portion towards the outer wall of the combustor wall structure for limiting the upstream flow of cooling air within the duct.

6. A wall structure according to claim 5, wherein a downstream end of an upstream wall element overlaps the upstream end of a downstream wall element.

7. A wall element for use as part of an inner wall of a gas turbine engine combustor wall structure including inner and outer walls, the inner and outer walls defining a duct therebetween, the wall element having a body portion aligned in use with a general direction of fluid flow through the combustor and a plurality of pedestals arranged to extend within the duct from the body portion towards the outer wall with the ends of the pedestals remote from the body portion lying substantially on a common plane, wherein the length of the pedestals towards the end of the body portion intended to be the downstream end of the wall element are of a greater length than the pedestals towards the end of the body portion intended to be the upstream end of the wall element.

8. A wall structure according to claim 2, wherein the inner wall includes a plurality of wall elements, each wall element having a body portion and an circumferentially extending sealing element that extends from the body portion towards the outer wall of the combustor wall structure for limiting the upstream flow of cooling air within the duct.

9. A wall structure according to claim 3, wherein the inner wall includes a plurality of wall elements, each wall element having a body portion and an circumferentially extending sealing element that extends from the body portion towards the outer wall of the combustor wall structure for limiting the upstream flow of cooling air within the duct.

10. A wall structure according to claim 4, wherein the inner wall includes a plurality of wall elements, each wall element having a body portion and an circumferentially extending sealing element that extends from the body portion towards the outer wall of the combustor wall structure for limiting the upstream flow of cooling air within the duct.

11. A wall structure according to claim 4, wherein the inner wall includes a plurality of wall elements, each wall element having a body portion and an circumferentially extending sealing element that extends from the body portion towards the outer wall of the combustor wall structure for limiting the upstream flow of cooling air within the duct,
wherein a downstream end of an upstream wall element overlaps the upstream end of a downstream wall element.

12. A wall structure according to claim 3, wherein the inner wall includes a plurality of wall elements, each wall element having a body portion and an circumferentially extending sealing element that extends from the body portion towards the outer wall of the combustor wall structure for limiting the upstream flow of cooling air within the duct,
wherein a downstream end of an upstream wall element overlaps the upstream end of a downstream wall element.

13. A wall structure according to claim 2, wherein the inner wall includes a plurality of wall elements, each wall element having a body portion and an circumferentially extending sealing element that extends from the body portion towards the outer wall of the combustor wall structure for limiting the upstream flow of cooling air within the duct,
wherein a downstream end of an upstream wall element overlaps the upstream end of a downstream wall element.

14. A wall structure according to claim 1, wherein the inner wall includes a plurality of wall elements, each wall element having a body portion and an circumferentially extending sealing element that extends from the body portion towards the outer wall of the combustor wall structure for limiting the upstream flow of cooling air within the duct,
wherein a downstream end of an upstream wall element overlaps the upstream end of a downstream wall element.
